(19) United States
(12) Patent Application Publication
(10) Pub. No.: US 2011/0056106 A1
(43) Pub. Date: Mar. 10, 2011

(54) I-JOIST FRAME SYSTEM WITH BEVELLED FRONT EDGE

(75) Inventor: George Thomas Bosma, Denver, CO (US)

(73) Assignee: George Thomas Bosma, Denver, CO (US)

(21) Appl. No.: 12/813,364

(22) Filed: Jun. 10, 2010

Related U.S. Application Data
(60) Provisional application No. 61/185,785, filed on Jun. 10, 2009.

(51) Int. Cl. A47G 1/06; B23P 11/00

(52) U.S. Cl. 40/700; 29/428

(57) ABSTRACT

This is a frame system that allows for the assembly of an artist frame and a surface material over the frame where there is no need for internal bracing of the frame and the contact area between the surface material and the frame is minimized. The framing system comprises pre-fabricated sections of a frame that incorporate an I-Joist design with a beveled edge lip on the front facing side. When these frame sections are assembled any stretchable material such as canvas, cloth, or plastic can be pulled over the front of the frame with the lip and connected to the back side at the top or bottom of the modular I-Joist frame.

### CROSS-REFERENCE TO RELATED APPLICATION

This application claims priority and the benefit of the filing date under 35 U.S.C. 119 to U.S. Provisional Application No. 61/185,785, entitled, “I-JOIST FRAME SYSTEM WITH BEVELED FRONT EDGE,” filed on Jun. 10, 2009, the contents of which are incorporated herein as if set forth in full.

### FIELD OF INVENTION

This invention relates generally to frames, surfaces and materials used by artists for painting, and drawing and to improvements in same. In particular, the invention relates to an improved stretcher frame and processes for making and using the frame.

### BACKGROUND

Artist stretcher frames to support canvas and other materials for painting and drawing have two common designs. One uses a stretcher bar and the other a strainer bar. Both of these designs have remained largely unchanged over the past five hundred years. While they both serve the purpose of holding the canvas or other art material, each is subject to persistent problems or aggravations. Among these are the need for corner bracing, significant areas where the canvas rests against the frame rather than being suspended between the frame sides, and difficulty of assembly

The art materials field, specifically the design of frames to support canvas and other materials for painting and drawing, generally use practices that were created in the 1400's. This is especially evident within the frame design and system used by the artists of today.

Frames became necessary when canvas, the most common support medium for oil paintings, replaced wooden panels as a surface. One of the earliest surviving oils on canvas is a French Madonna with angels from around 1410 in the Gemaldegalerie, Berlin. Panel painting remained more common until the 16th century in Italy and the 17th century in Northern Europe. At this time Venetian artists lead a change as Venetian sail canvas became readily available. This canvas material is stretched across a wooden frame called a stretcher.

Since a stretcher is simply a frame, it can be constructed in a variety of ways. The differences in construction have been limited to how the corners are built. The two current designs for art frames are the Stretcher Bar and the Strainer Bar. The difference between them is largely in the design of the corners and the method of strengthening the frame.

The stretcher bar frame uses wooden pieces that have interlocking corners that fit together like puzzle pieces and are typically tightened and strengthened with triangular shaped wedges. The miter joint is the most popular method of adhering corners on a stretcher. Small triangle wedges or keys are inserted in the joint after the canvas is stretched to give the canvas its final tension. When fastening the canvas, pressure needs to be distributed evenly around the stretcher to minimize any warping due to unequal distribution of pull. The corner joints in stretcher bars are not glued or fastened in any permanent way. This allows the canvas to be re-tensioned over time, as it has a natural tendency to stretch and sag over time. In contrast, strainer bars stretch canvas in a fixed, non-adjustable way.

A strainer bar frame is constructed in a fixed way with solid pieces of wood where corners are glued or attached and the frame is strengthened with corner braces. Strainer bars are fixed to one another with wood glue, staples or nails or a combination of these. Strainer bar frames are often reinforced with other fixed elements such as corner and cross braces. These frames are not built to accommodate the insertion of tightening keys into their corners to tighten the canvas stretched upon them as a stretcher bar frame would.

Currently available frame designs for stretcher and strainer bar frames, including pre-fabricated frames, rely on an internal support brace. The frame needs some type of internal bracing to support both the canvas or art material and the frame itself. The natural tendency of canvas in particular, and other materials generally, is that they tighten when gesso, paint or other artistic material is applied to the surface. Wooden frames in particular bow or bend as the art material tightens. In both the stretcher bar and strainer bar design the frame often requires additional internal bracing in the form of cross bars that go from one side of the frame to the other.

Common examples of bracing are triangle wedges, keys, corner and cross braces previously mentioned. As one example, one of the largest online supplier of art frames, Art98, has claimed to have 99,000 stretcher bars in stock. It had described the multi-step process of putting together and strengthening a frame with multiple cross braces and corner wedges as follows:
1. Before adding opposite sides insert cross braces, if you need them.
2. Insert another cross brace and the brace tenon into mortise.
3. Insert mortise into brace, and connect last corner.
4. Gently hammer together all corners and brace joints with a mallet until they are firmly in place and the corners are flush.
5. Insert wedge into corner and then repeat process on the other corner braces.

All current frame systems and framing options require a significant amount of time to assemble the frame because of the need for bracing before the canvas or art material can be stretched. This requirement of current frame designs and systems can entail as many as eighteen different steps before the canvas or art material is properly attached to the frame. It also makes it difficult and time consuming to un-assemble the frame support should the painting need to be removed for transit.

Additionally, in existing frame designs, the wood or other material that forms the front of the frame where the canvas is stretched is flat. The width of this flat surface is generally proportional to the size of the frame. In other words, a frame that is two feet by two feet might require that each side of the frame have a one-inch width surface. And a frame that is ten feet by ten feet might require a two or three inch frame surface. The canvas or other support material is generally wrapped around this flat surface on each of the four sides of the frame. Only the very center of the frame has a suspended surface. As a result, the area where the canvas or other support material wraps around the frame and is not suspended has a tendency to change the complexion and appearance of the painted or drawn upon surface. Sometimes the wooden frame area even shows through the canvas. In effect this makes this area of the canvas or painting surface difficult to work with for many artists and can cause a visual blemish.

Abstract artist Robert Terrell who has had shows in New York, Texas and California describes this common problem and the time consuming solution of attaching quarter round to the frame in an article entitled Building Painting Stretchers on the web site artinfosite.info:

“Canvas must be raised up off the stretcher or it will leave a mark where it touches the wood (where the brush presses the canvas against the stretcher as you paint). So, for this method of stretcher construction, you will use quarter round also found at home improvement stores). It is a long piece of molding, curved on one side, with two other flat sides at a 90 degree angle. You will use brad nails (a brad nail gun and compressor can be bought for around $150—worth the money!—and you can get a stapler for stretching the canvas, too) and glue to affix the quarter round to the stretcher sides. A flat side goes against the outside edge of the stretcher curved edge goes to the inside.”

Internal bracing systems are costly and time consuming for assembly. Existing internal bracing systems are not sufficiently strong to completely prevent warping of one or more of the sides of a large frame over a period of time. Existing frame designs have a large surface area that contacts with and distorts the artwork.

The ideal artist frame and frame system should have qualities that provide sufficient strength for the canvas and frame without the need for internal bracing and with a frame surface that minimizes the contact with the surface of the canvas. The ideal frame and frame systems should provide minimal contact with the canvas or other art surface, maximum suspension of the art surface and an entirely level surface. Contact between the frame and the art surface produces an unnecessary and undesirable edge. This is a common problem for existing frames and frame systems which makes it more difficult for the artist to create their work and produces an unwanted visual effect where they overlap. The frame should also be able to withstand mechanical impacts, so that dropping the frame should result in minimal damage to the painting.

Further, existing frames and bracing systems can produce a surface area that is not entirely level when the canvas or other materials is stretched. This results when in particular an external corner brace raises the height of the canvas at the edge of the frame. One result is that the back side of the painting does not hang flush against the wall. This creates a visually distracting appearance.

The following patents relate to artist frames:

U.S. Pat. No. 6,520,240 titled “Bracing system for canvas stretcher frames” issued to John M. Sooklaris on Feb. 18, 2003 describes a bracing system that allows for positioning of one or more braces in a stretcher bar frame to prevent the inward pulling of the frame under canvas tension. This system illustrates the need for internal bracing in conventional frame systems.

U.S. Pat. No. 6,138,741 titled “Stability stretcher frame” issued to John Stobart on Oct. 31, 2000 describes a canvas tensioning picture frame which is formed by a plurality of abutting frame members and is provided with a tapered screw. One feature of this invention is a screw assembly in the corner of a picture frame that holds together the corners.

U.S. Pat. No. 4,255,886 titled “Artist canvas stretcher frame brace bracket” issued to Wallace Klarman on Mar. 17, 1981 describes a movable brace that can move transversely across the back of a frame and is held in place by movable plastic socket members on each end of the brace. This does not eliminate the need for bracing of the frame, nor does it minimize the contact between the canvas or other art material and the sides of the frame.

### SUMMARY OF THE INVENTION

The present invention overcomes many of the specific drawbacks related to existing designs of frames and frame systems. The invention eliminates the need for internal bracing to support the canvas. The invention eliminates protruding corner bracing. The beveled edge lip of the invention significantly reduces the amount of the frame which the canvas or other art material must rest against to a ¼″ surface which is less than any other frame system. The invention provides easy of assembly that is not available with other designs or systems.

In one embodiment, a stretcher frame constructed in accordance with the present invention comprises pre-fabricated sections of wood or other material which constitute the sides of a frame. These sections incorporate an I-Joist design wherein one piece of wood (or other material) sits on top of a thinner connecting piece that is attached to a third piece. The I-Joist is a design that has been used for wood frames in the building trades industry. The Wood I-Joist Manufacturers Association represents more than twenty five organizations around the world that specifically manufacture and sell prefabricated wood I-Joists for construction. The I-Joist provides a level of strength and stability for framing many parts of a building including roofs and decks.

In accordance with one aspect of the present invention, the structural capability of the I-Joist is used in a new and unique manner by applying it to the art frame. The structural stability of the I-Joist creates a stronger frame that is not possible with existing frame systems that simply use solid pieces of wood and thus require bracing support. Specifically, the frame includes four side pieces where each side piece includes an outer web, an inner web and a central web outer between the outer and inner webs. The webs can be formed from wood and may generally be configured to form an I-Joist. The side pieces are connected end-to-end at the corners to form the frame. For example, the side pieces may be cut to form complementary angles, e.g., each end of the side pieces may be cut at a 45° angle.

In accordance with another aspect of the present invention, the functionality of the I-Joist is enhanced in its application in art frames. Specifically the top piece of wood (or other material) of the I-Joist is crafted with a beveled edge or otherwise includes a portion that is separated rearwardly from the back of the canvas. This edge faces towards the front of the frame. It creates a lip over which the canvas or other support material is stretched. The lip ensures that the canvas hangs flat and simultaneously minimizes the amount of the frame which touches the canvas. This minimizes any marks or edges where the canvas normally hits the edge of a frame.

In accordance with a still further aspect of the present invention, a pre-fabricated L-shaped insert or corner component, for example, fabricated from oriented strand board (OSB) or medium density fiber board (MDF), fits into channels formed in the frame sides, e.g., the insert may be inserted into the corner of the frame where the I-Joists connect. This insert enhances the structural strength of the frame and eliminates the need for internal bracing such as cross braces, corner braces, keys or triangle wedges.

The present invention provides a framing system that improves the structure and functionality of an art frame at the same time that it reduces the amount of time and elements involved in creating a frame. Specifically, the system may include a total of eight pieces. Four pre-cut sections which become the sides of the frame and four pre-cut inserts which strengthen the corners of the frame.

This new system offers complete flexibility in terms of the finished size of the frame. This is generally not available in pre-fabricated strainer bar frames or frame systems. That is because these frame systems, while they do offer different lengths of sides, are generally available only in pre-determined lengths. They come with corners that lock into each other. So, for example, if you want to create a three feet by two foot frame you would purchase two three feet and two, two foot lengths. However, if you want to create a three foot—two inch by two foot five inch frame it will not be an available option with currently available frames and frame systems.

This problem is described by Renae De Leon, eHow Editor of the popular web site eHow.com. She writes in an article How to Make Canvas Stretcher Bars: “Canvas stretcher bars, as their name suggests, are used to stretch a piece of canvas. Stretching canvas makes it easier to paint on. While you can buy these bars in a store, it is difficult to find them in measurements of under 8 inches or over 24 inches. Half sizes are also difficult to find.”

The design of the present invention allows artists to decide exactly which size frames they want. For example, they can purchase pre-fabricated sections that are slightly larger than the size they want. Then, using a simple mitre box they cut the corners of the frame. Thus, any length for any side can be rapidly made by the user. In accordance with a further aspect of the present invention assembly of a strong frame with the system may entail:
1. Cutting the corners (e.g., at a 45 degree angle) to the lengths desired for the frame.
2. Connecting the corners together (e.g., using an adhesive such as wood glue).
3. Inserting the L-shaped corners into the side channels at the corner. The corner inserts may be attached by adhesives or screws.

In addition to flexibility in the creation of a variety of frame sizes, this invention provides, in accordance with another aspect thereof, for re-use as well as re-assembly. Should the artist decide he does not want the current frame he can easily reuse the existing frame and/or cut any of the sides and immediately have a new frame. This is possible because the I-Joist design provides for re-usable corner connectivity. With standard stretcher bar systems the corners can only be used in the size they are purchased in. This is a significant advantage of the invention. Further, if the user screws the corners together the frame can easily be un-assembled and re-assembled later. This is quite useful when artwork, especially large artwork, has to be shipped because the canvas can be rolled up, the frame sections bundled and everything shipped in a small container which not only saves money but protects the artwork.

Another aspect of the present invention is that the wide sides of the pre-fabricated sections have a two-inch profile that is ready for what is known in the field as gallery wrapped edges. What this means is that when the artwork is complete the frame can be hung on a wall as-is without an additional frame being placed over the artwork. It is both an element of structural integrity because of the wide profile as well as aesthetic enhancement as the artwork moves out from the wall.

Because the system incorporates an I-Joist design in the sides of the frame, in one embodiment, there is an existing channel formed directly in the frame. This channel performs a number of important functions. One function the channel performs is to allow the artist to easily glue and lay down the pre-fabricated corner inserts into each corner. It does not matter which size frame the artist decides to create; the corner inserts will work in any size frame. These inserts provide additional strength and prevent the need for any other type of internal or external bracing for the frame. The frame is complete.

The present invention saves a tremendous amount of time in assembly of the completed frame. The assembly steps can be performed in less than ten minutes for any size frame, significantly less time than commonly required for assembly of conventional frames.

Another improvement associated with the present invention is that the I-Joist with the channel creates two different places for the artist to attach the canvas to the frame as it is stretched. There is a top piece of wood and, below the channel, a second piece of wood. The artist can attach with staples or small tacks, the canvas to one or both of these locations to secure and stretch the canvas.

### BRIEF DESCRIPTION OF THE DRAWINGS

For a more complete understanding of the present invention and further advantages thereof, reference is now made to the following detailed description taken in conjunction with the drawings in which:

FIG. 1 is a rear view of the entire frame showing four L-shaped corner inserts in the channel of the I-Joist.

FIG. 2 is a rear view of the entire frame with canvas or other art material wrapped around the frame and attached with staples or tacks to both sides of the I-Joist.

FIG. 3 is a side view, showing how the canvas or art material wraps around the frame and attaches with staples or tacks to the I-Joist.

FIG. 4 is a cut-away view of a corner section of the pre-fabricated frame length wherein the beveled lip at the front of the frame, the I-Joist design, and the attachment points where the canvas or art material can be attached to the frame are illustrated; and the L-shaped corner insert is shown by hash marks.

FIG. 5 is a side view showing the frame components including three elements which, when fabricated, form an I-Joist design wherein the top front of the frame has a beveled edge to suspend the canvas or other art material.

FIG. 6 is a front view of the three elements of FIG. 5 assembled to form an I-Joist that forms the frame wherein the top element has a beveled edge that faces the front of the frame and abuts the rear surface of the canvas.

FIG. 7 is a rear view close-up of two mitered and assembled lengths attached to form a corner wherein a pre-fabricated L-shaped insert is placed in the channel of the I-Joist to provide frame strength.

FIG. 8 depicts one of the L-shaped inserts (corner component).

### DETAILED DESCRIPTION OF THE INVENTION

The present invention now will be described more fully hereinafter with reference to the accompanying drawings, in which some examples of the embodiments of the inventions are shown. Indeed, this invention may be embodied in many different forms and should not be construed as limited to the embodiments set forth herein; rather, these embodiments are provided by way of example so that this disclosure will satisfy applicable legal requirements. Like numbers refer to like elements throughout.

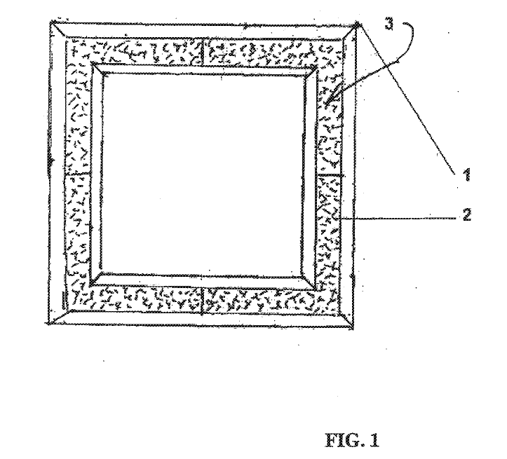

FIG. 1 shows schematically the back side of a typical completed frame constructed with the present invention. The frame has four sides. The ends of the sides are preferably formed to facilitate adhesive attachment, e.g., using wood glue in the case of wooden construction. In the illustrated example, the ends have been mitered at 45 degrees and attached at interface 1. These corners can be attached with glue as noted or screws as is desired by the user. As discussed above, the use of screws enables disassembly and re-assembly, e.g., for convenient shipping. The frame is shown face down and the I-Joist design can be seen wherein a channel 2 is created between the top and bottom of each side. In FIG. 1 a pre-fabricated L-shaped insert 3 which is part the present invention and composed of oriented strand board (OSB) has been inserted into each corner channel. Alternatively, the insert 3 can be constructed from medium density fiber board (MDF) cut with an automated router. In this example these inserts which are typically six inches per side and about 1 inch deep, but can be pre-fabricated in other lengths, butt up against the mitered corners of the I-Joist. It should be appreciated that the inserts need not extend about the full periphery of the frame.

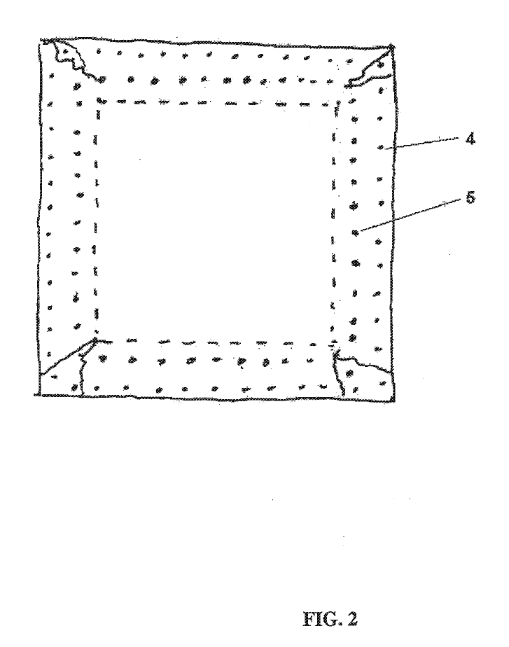

FIG. 2 shows a back view of the frame wherein a canvas or other art material has been stretched over the front of the frame. Corners of the art material are folded at the corners of the frame and the art material is attached, typically with staples or tacks, to both the top (outermost) 4 and the bottom (innermost) 5 webs of the I-Joist which are level on the back side and provide for two surfaces for said attachment.

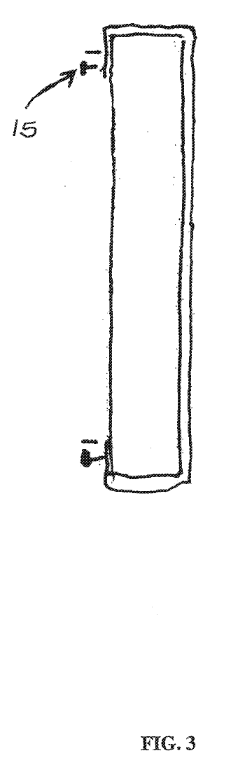

FIG. 3 shows in side view how the canvas or other art material can be stretched and wrapped from the front to the back of the frame and attached using staples or tacks 15.

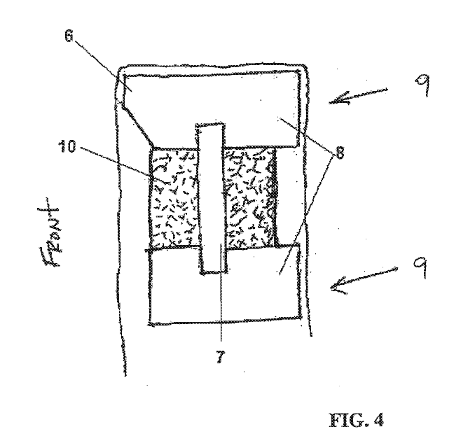

FIG. 4 shows a cut-away of a section of the pre-fabricated frame length at the corner. The ¼″ beveled lip 6 which supports and suspends the canvas or other art material at the front of the frame is apparent. The I-Joist design of the pre-fabricated length is apparent with a center piece 7 that may be composed of plywood and attached to two other pieces or webs of material 8 that may be composed of pine wood or other material. Attachment points 9 where the canvas or art material can be attached to the frame are noted and the L-shaped corner insert 10 made from OSB or MDF is shown.

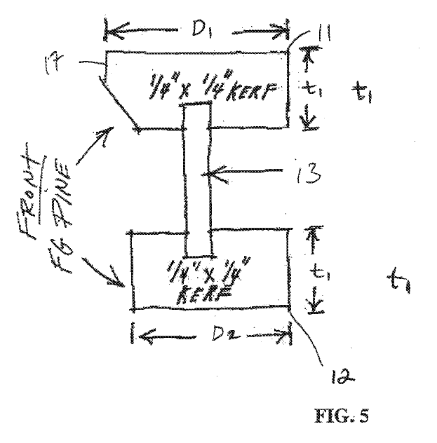

FIG. 5 shows a side view that illustrates the components of a pre-fabricated length which comprises three elements which, when fabricated, form an I-Joist design. The top 11 and bottom elements 12 may be of pine wood or other material and the center element 13 may be of plywood or other material. The top element 11 is fabricated with a ¼″ beveled edge 17 to suspend the canvas or other art material. The top element 11 has a depth D₁ that is preferably greater than the depth D₂ of the bottom element 12 such that the top element 11 protrudes forwardly of the bottom element 12. In this manner, the bottom element 12 is separated from the canvas. Each of the elements 11, 12 may have a thickness t₁ of about ¾ inche, though this can be varied depending on the application. In the illustrated embodiment, the dimensions of the center element 13 can be about ¼ inch by 1½ inches. The elements 11, 12, 13 can be attached using an adhesive such as wood glue.

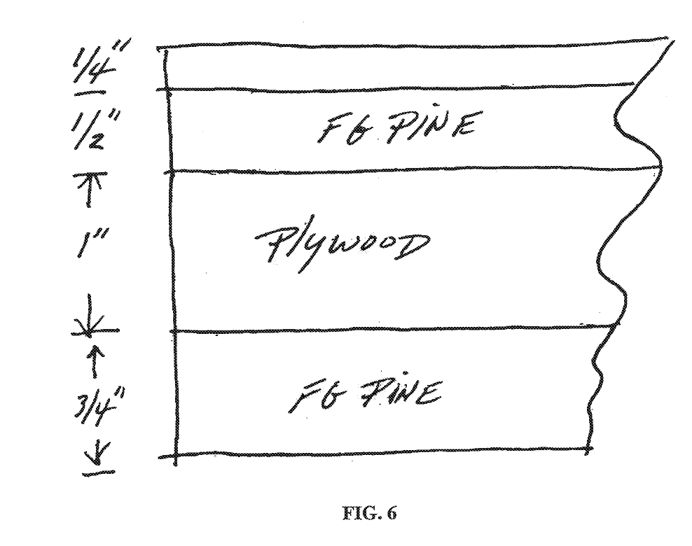

FIG. 6 shows a front view that illustrates the three assembled elements that comprise the pre-fabricated lengths of the frame.

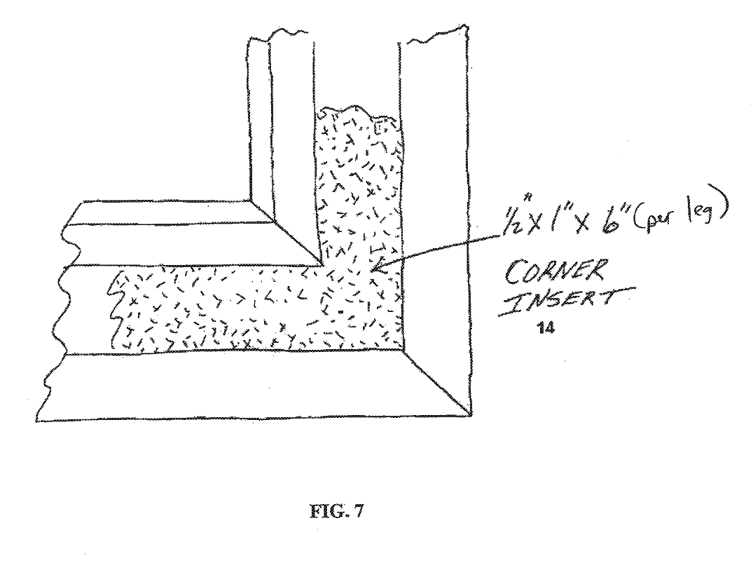

FIG. 7 shows a close up of the back corner of a frame wherein two pre-fabricated lengths are miter cut at 45 degree angle and assembled to form a corner. The pre-fabricated L-shaped insert 14 of the present invention, which is constructed of OSB or MDF, is placed in the channel of the I-Joist to provide additional frame strength and thereby eliminate the need for other types of internal bracing.

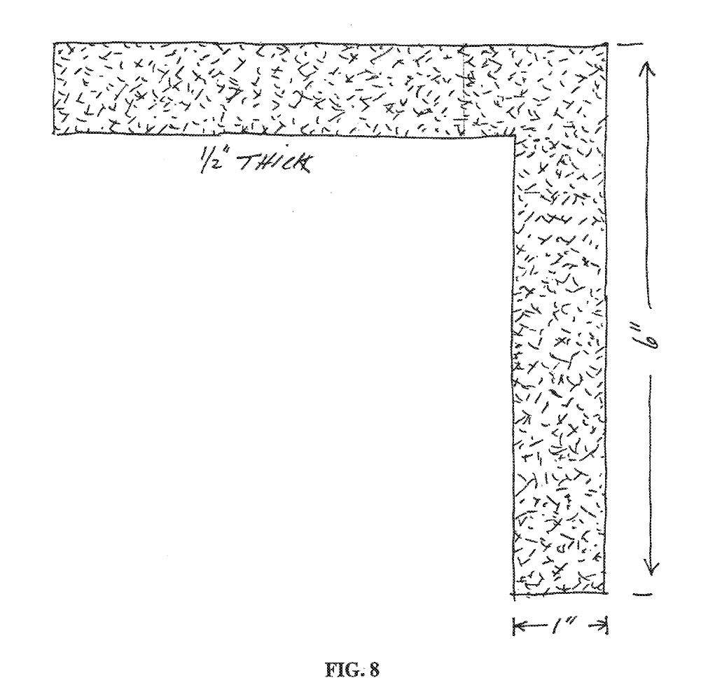

FIG. 8 depicts one of the L-shaped inserts, a corner component of the present invention, with typical dimensions and fabricated from OSB or MDF.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed:

1. A frame for supporting a canvas art surface, comprising:
first, second, third and fourth side pieces, each of said side pieces formed from a generally I-shaped structure comprising an outer web, an inner web and a central web interconnecting the outer web and the inner web; and
first, second, third and fourth corner connections, each for interconnecting adjacent ones of said side pieces to form side frame, wherein said outer webs of said side pieces define an outer periphery of said frame.

2. A frame as set forth in claim 1, wherein each of said first, second, third and fourth side pieces is formed from wood.

3. A frame as set forth in claim 1, wherein said corner connections are defined by forming ends of adjacent ones of said side pieces at complementary angles such that the said adjacent side pieces can be attached to form a substantially right angle corner.

4. A frame as set forth in claim 3 wherein at least one of said corner connections further comprises an internal corner brace piece dimensioned to be received in channels formed in each of said adjacent side pieces.

5. A frame as set forth in claim 1 wherein, each of said outer webs includes a front surface adjacent a back side of said canvas art surface, said front surface having a first portion for abutting said back side of said canvas and a second portion that is separated rearwardly from said back side of said canvas thereby reducing a contact surface area between said front surface of said outter web and said back side of said canvas.

6. A frame for supporting a canvas art surface, comprising:
first, second, third and fourth side pieces, each of said side pieces having a front for facing a back surface of said canvas, said front including an inner portion and an outer portion where said outer portion extends forward of said inner portion to define a front canvas contact surface having canvas contact area less than an area of said front; and
first, second, third and fourth corner connections, each for interconnecting adjacent ones of said side pieces to form side frame, wherein said outer portions of said side pieces define an outer periphery of said frame.

7. A frame as set forth in claim 6, wherein each of said first, second, third and fourth side pieces is formed from wood.

8. A frame as set forth in claim 6, wherein said corner connections are defined by forming ends of adjacent ones of said side pieces at complementary angles such that the said adjacent side pieces can be attached to form a substantially right angle corner.

9. A frame as set forth in claim 6, wherein at least one of said cornver connections further comprises an internal corner brace piece dimensioned to be received in a channel formed in each of said adjacent side pieces.

10. A frame for supporting a canvas art surface, comprising:
first, second, third and fourth side pieces, each of said side pieces having a recessed channel formed in one of the faces thereof and extending along at least a portion of a length of said side piece; and
first, second, third and fourth internal corner brace pieces, each said corner piece having a first leg dimension to be received within one of said channels of a respective one of said side pieces and a second leg dimension to be received in another one of said channels of another one of said side pieces.

11. A frame as set forth in claim 10, wherein each of said first, second, third and fourth side pieces is formed from wood.

12. A frame as set forth in claim 10, wherein ends of adjacent ones of said side pieces are formed at complementary angles such that the said adjacent side pieces can be attached to form a substantially right angle corner.

13. A frame as set forth in claim 10, wherein, each of said side pieces includes a front surface adjacent a back side of said canvas art surface, said front surface having a first portion for abutting said back side of said canvas and a second portion that is separated rewardly from said back side of said canvas thereby reducing a contact surface area between said front surface of said side piece and said back side of said canvas.

14. A method for forming a frame to support a canvas art surface, comprising the steps of:
providing one or more I-shaped joists comprising an outer web, an inner web and a central web interconnecting the outer web and the inner web;
cutting the one or more joists to form first, second, third and fourth side pieces of desired lengths; and
interconnecting adjacent ones of said first, second, third and fourth side pieces to form said frame, wherein said outer webs of said side pieces define an outer periphery of said frame.

15. A method as set forth in claim 14, wherein said first, second, third and fourth side pieces formed from wood.

16. A method as set forth in claim 14, wherein said step of cutting comprises forming ends of adjacent ones of said side pieces at complementary angles such that the said adjacent side pieces can be attached to form a substantially right angle corner.

17. A method as set forth in claim 14, further comprising forming said side pieces such that each of said outer webs includes a front surface adjacent a back side of said canvas art surface, said front surface having a first portion for abutting said back side of said canvas and a second portion that is separated rearwardly from said back side of said canvas thereby reducing a contact surface area between said front surface of said outter web and said back side of said canvas.

18. A method for using a frame for supporting a canvas art surface, comprising the steps of:
providing first, second, third and fourth side pieces, each side piece having a channel formed therein, and first, second, third and fourth corner pieces dimensioned to be received within said channels of said side pieces;
assembling a frame by inserting said first, second, third and fourth corner pieces into the channels of said first, second, third and fourth side pieces;
disassembling said frame by removing said first, second, third and fourth corner pieces from said channels of said first, second, third and fourth side pieces; and
reusing at least one of said corner pieces or side pieces in forming a second frame, the same as or different than said first frame.
